(19) United States
(12) Patent Application Publication
(10) Pub. No.: US 2008/0126416 A1
(43) Pub. Date: May 29, 2008

(54) METHOD OF DRIVING AN ELECTRONIC ELEMENT THROUGH FILE PROCESSING

(76) Inventors: Han-Chin Hsu, Hsinchu City (TW); Ying-Jie Huang, Hsinchu City (TW)

Correspondence Address: SCHMEISER, OLSEN & WATTS, 22 CENTURY HILL DRIVE, SUITE 302, LATHAM, NY, 12110, US

(21) Appl. No.: 11/772,855

(22) Filed: Jul. 3, 2007

(30) Foreign Application Priority Data
Apr. 7, 2006 (TW) 095124381

(51) Int. Cl. G06F 17/00

(52) U.S. Cl. 707/104.1; 707/E17.005

(57) ABSTRACT

In a method of driving an electronic element through file processing, an electronic element signal processing interface is connected to an electronic operating platform and the electronic element, so that various signals of the electronic element could be directly processed using a file process unit of an existing operating system on the electronic operating platform without the need of using a particular driver or application to drive the electronic element. Therefore, the signal file for driving the electronic element could be quickly transmitted and processed over a network to largely reduce the inconveniences of an engineer in re-writing a driver.

### FIELD OF THE INVENTION

The present invention relates to a method of driving an electronic element through file processing, and more particularly to a method of driving an electronic element through an electronic element signal processing interface and a computer.

### BACKGROUND OF THE INVENTION

Following the highly developed electronic technology, and the increasing growth in consumers' demands for various kinds of electronic chips, such as RAM (random access memory), ROM (read-only memory), DRAM (dynamic random access memory), Flash, EPROM (erasable programmable read-only memory), and EEPROM (electrically erasable programmable read-only memory), more and more electronic operating platforms, such as personal computers, workstations, personal digital assistants (PDAs), digital still cameras (DSCs), etc., have been developed for use. These electronic operating platforms generally have different operating system platforms.

Generally, an electronic element research and development engineer working on an electronic operating platform would have to use a particular driver or application to drive an electronic element, so as to study and improve the operating characteristics of the electronic element. When the study of the electronic element is conducted on a different electronic operating platform or using a different operating system, the engineer has to develop a new driver or application for driving the same electronic element. And, these particular drivers or applications for driving the electronic element can only be transmitted in a non-storage medium form at a low speed, and could not be transmitted, controlled, or browsed over a network, resulting in unnecessary waste of time and labor in research and development.

It is therefore desirable to develop a method of driving an electronic element, so that there is no need to use a particular driver or application to drive an electronic element, and a file processing unit of an operating system on an existing electronic operating platform is directly used to process various signals of the electronic element. With the method, the processed file for driving the electronic element could be quickly transmitted, controlled, and browsed over a network.

### SUMMARY OF THE INVENTION

A primary object of the present invention is to provide a method of driving an electronic element through file processing, so that an electronic element research and development engineer does not need to use a particular driver or application on an electronic operating platform to drive an electronic element for studying different operating characteristics of the electronic element.

Another object of the present invention is to provide a method of driving an electronic element through file processing, so that an electronic element research and development engineer does not need to develop a new driver or application for driving the same electronic element on a different electronic operating platform or with a different operating system in the process of studying the operating characteristics of the electronic element.

A further object of the present invention is to provide a method of driving an electronic element through file processing, so that the processed file for driving the electronic element could be quickly transmitted, controlled, or browsed over a network to largely reduce the time and labor needed in research and development of the electronic element.

To achieve the above and other objects, the method of driving an electronic element through file processing according to the present invention includes the following steps:

(1) Connect an electronic element signal processing interface to an electronic operating platform and an electronic element; the electronic operating platform having an operating system, at least one file processing unit, and a message display unit;

(2) The operating system queries the electronic element signal processing interface about a type thereof;

(3) The electronic element signal processing interface replies to the operating system that it is a data storage device;

(4) The electronic element signal processing interface reads in at least one signal stored on the electric element;

(5) The electronic element signal processing interface converts the read signal into a signal file that could be edited by the file processing unit, and gives the signal file a filename, which is stored on the electronic element signal processing interface;

(6) The file processing unit opens the signal file;

(7) Use the file processing unit to edit the signal file;

(8) The electronic operating platform stores the edited signal file on the electronic element signal processing interface;

(9) The electronic element signal processing interface converts the edited signal file into at least one edited signal, and stores the edited signal on the electronic element; and

(10) The electronic element restarts operating according to the edited signal.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a conceptual view showing an example of driving an electronic element through file processing using the method of the present invention;

FIG. 2 is a conceptual view showing another example of driving an electronic element through file processing using the method of the present invention; and

FIG. 3 is a flowchart showing the steps included in the method of driving an electronic element through file processing according to an embodiment of the present invention.

### DETAILED DESCRIPTION OF THE PREFERRED EMBODIMENTS

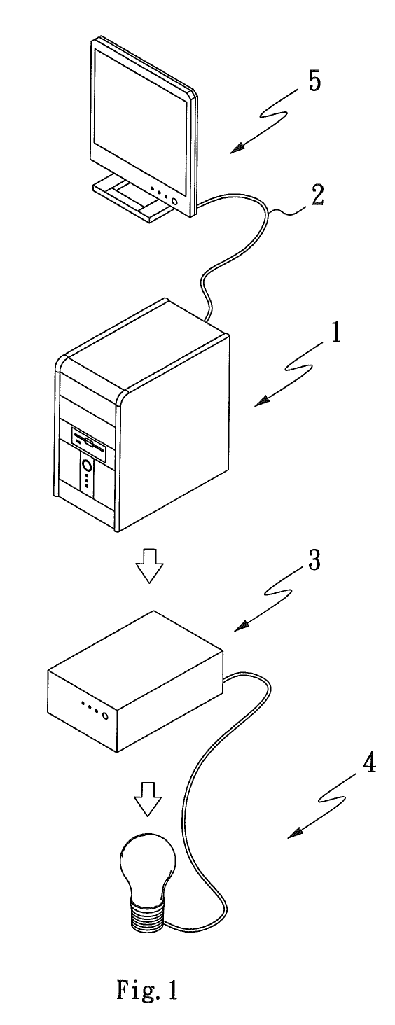

Please refer to FIG. 1 that is a conceptual view showing a first example of driving an electronic element through file processing using a method according to a preferred embodiment of the present invention. As shown, an electronic element signal processing interface 3 is connected to an electronic operating apparatus 1, such as a personal computer (PC), a workstation, a personal digital assistant (PDA), or a digital still camera (DSC), via a transmission interface 2, which may be, for example, ATA, ATAPI, SATA, USB, 1394, SD, MMC, MS, XD, Smart Media, UWB, Bluetooth, or LAN. At this point, an operating system installed on the electronic operating apparatus 1 would query the electronic element signal processing interface 3 about a type thereof, and the electronic element signal processing interface 3 would reply to the operating system that it is a disk drive, and a display screen 5 connected to the electronic operating apparatus 1 would display that the operating system has found a newly added disk drive. Then, the electronic element signal processing interface 3 is connected to an electronic element, which may be an electronic element of any type. To enable easy description of the method of the present invention, the illustrated electronic element 4 in the first example of application of the present invention in FIG. 1 is a lamp bulb. The lamp bulb 4 has a start signal in an “off” state. The electronic element signal processing interface 3 reads in the start signal and sets it to “0”, and converts the signal into a signal file and gives it a filename, such as, for example, signal.txt, signal.doc, or signal.wav. A file processing unit, which may be a file editing system, such as Notepad or Word, is used to edit the signal file. The edit may include actions of overwrite, copy, delete, edit, browse, change filename, modify file attribute, etc. Use the file processing unit to change the signal to be “1”, which is then stored on the electronic element signal processing interface 3. The electronic element signal processing interface 3 further converts the changed signal file into a signal in an “on” state. And, the lamp bulb 4 is driven to light.

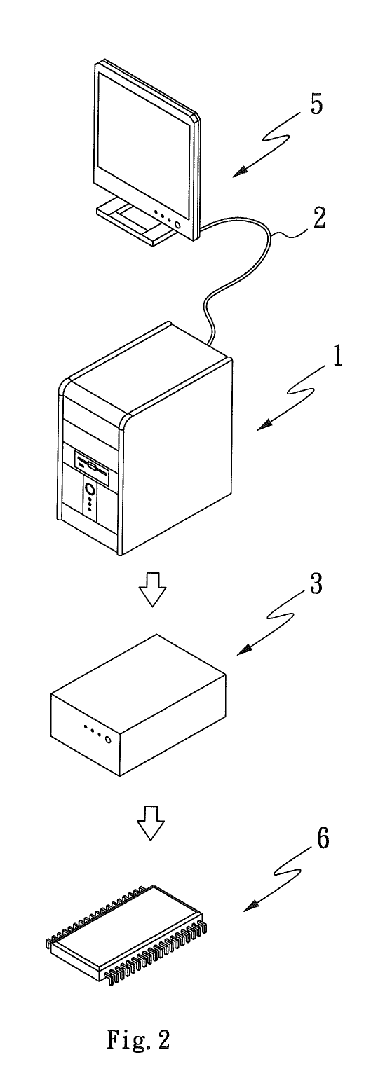

FIG. 2 is a conceptual view showing a second example of driving an electronic element through file processing using a method according to a preferred embodiment of the present invention. As shown, an electronic element signal processing interface 3 is connected to an electronic operating apparatus 1, such as a personal computer (PC), a workstation, a personal digital assistant (PDA), a digital camera, a digital video camera, a computer for industrial controlling, or a smart mobile phone, via a transmission interface 2, which may be, for example, ATA, ATAPI, SATA, USB, 1394, SD, MMC, MS, XD, Smart Media, UWB, Bluetooth, or LAN. At this point, an operating system installed on the electronic operating apparatus 1 would query the electronic element signal processing interface 3 about a type thereof, and the electronic element signal processing interface 3 would reply to the operating system that it is a disk drive, and a display screen 5 connected to the electronic operating apparatus 1 would display that the operating system has found a newly added disk drive. Then, the electronic element signal processing interface 3 is connected to an electronic element 6, which may be, for example, a RAM, a ROM, a DRAM, a Flash, an EPROM, or an EEPROM. The electronic element 6 has a start signal, which may be a voltage signal, a current signal, an on/off signal, or a frequency signal, and is in an “on-on-off-off-on-on-off-off” state. The electronic element signal processing interface 3 reads in the start signal and sets it to “11001100”, and converts the signal into a signal file and gives it a filename, such as, for example, signal-1.txt, signal-1.doc, or signal-1.wav. A file processing unit, which may be a file editing system, such as Notepad, Word, or an image browsing and editing program, to edit the signal file. The edit may include actions of overwrite, copy, delete, edit, browse, change filename, modify file attribute, etc. The file processing unit is used to change the start signal to be “00110011”, which is then stored on the electronic element signal processing interface 3. The electronic element signal processing interface 3 further converts the changed signal file into a signal in an “off-off-on-on-off-off-on-on” state. And, the electronic element 6 is driven again to an operating mode.

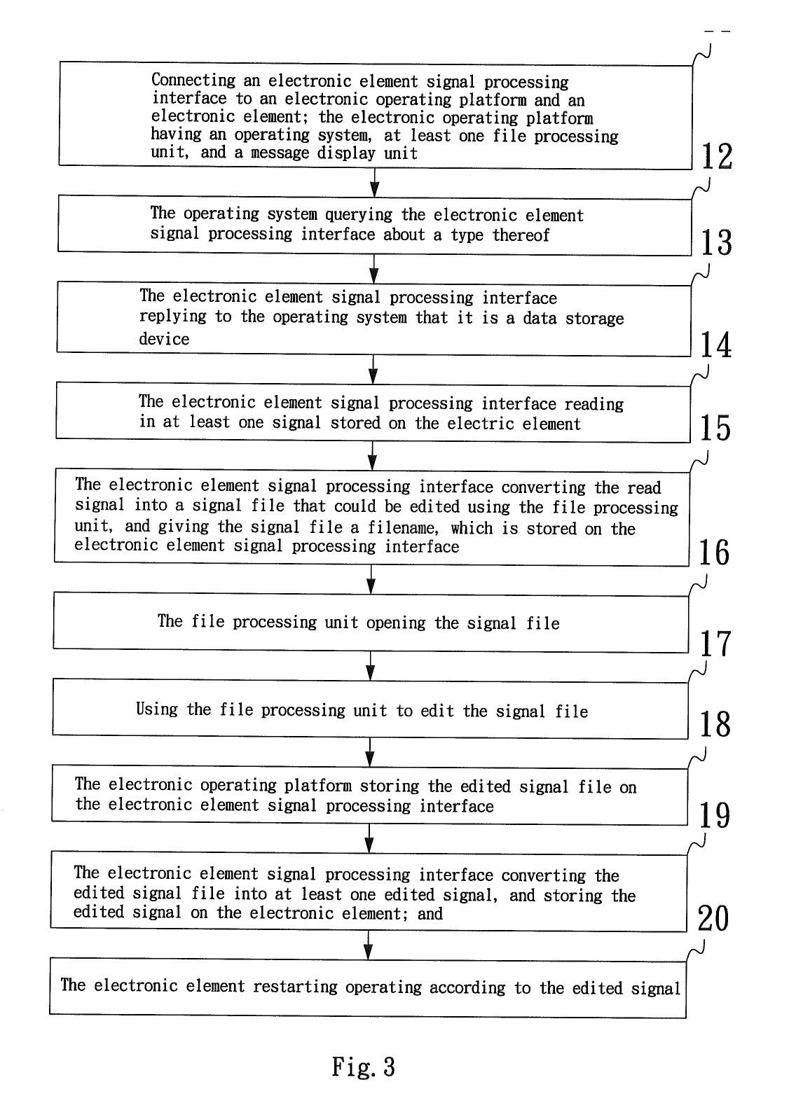

FIG. 3 is a flowchart showing the steps of driving an electronic chip in the method according to an embodiment of the present invention. The steps are as follows:

(1) Connect an electronic element signal processing interface to a computer and an electronic chip; wherein the computer has an operating system, a text editing system, and a screen;

(2) The operating system queries the electronic element signal processing interface about a type thereof;

(3) The electronic element signal processing interface replies to the operating system that it is a data storage device;

(4) The electronic element signal processing interface reads in a signal stored on the electric chip;

(5) The electronic element signal processing interface converts the read signal into a signal file that could be edited using the text editing system, and gives the signal file a filename, such as signal.txt, which is stored on the electronic element signal processing interface;

(6) Use the text editing system to open the signal.txt file;

(7) Use the text editing system to edit the content of the signal.txt file;

(8) The computer stores the edited signal.txt file on the electronic element signal processing interface;

(9) The electronic element signal processing interface converts the edited signal.txt file into an edited signal, and stores the edited signal on the electronic chip; and

(10) The electronic chip restarts operating according to the edited signal.

The method of the present invention is characterized in that it does not use any particular driver or application to drive an electronic element, but directly uses a file processing unit of an existing operating system on an electronic operating platform to process various signals of the electronic element, so as to achieve quick file transmission and other file processing actions over a network.

The method of the present invention has overcome the problems in the prior art, such as requiring a particular driver or application to drive an electronic element on an electronic operating platform, requiring the development of new driver or application to drive an electronic element on a different electronic operating platform or with a different operating system, unable to quickly transmit the particular driver or application in the form of a storage medium, unable to transmit, control, or browse the particular driver or application over a network, and wasting a lot of time and labor in research and development of particular driver or application for driving an electronic element. Therefore, the present invention is novel and improved to meet the requirement of patentability, and is industrially useful to meet market demands.

What is claimed is:

1. A method of driving an electronic element through file processing, comprising the steps of:
(1) Connecting an electronic element signal processing interface to an electronic operating platform and an electronic element; the electronic operating platform having an operating system, at least one file processing unit, and a message display unit;
(2) The operating system querying the electronic element signal processing interface about a type thereof;
(3) The electronic element signal processing interface replying to the operating system that it is a data storage device;
(4) The electronic element signal processing interface reading in at least one signal stored on the electric element;
(5) The electronic element signal processing interface converting the read signal into a signal file that could be edited using the file processing unit, and giving the signal file a filename, which is stored on the electronic element signal processing interface;
(6) The file processing unit opening the signal file;
(7) Using the file processing unit to edit the signal file;
(8) The electronic operating platform storing the edited signal file on the electronic element signal processing interface;
(9) The electronic element signal processing interface converting the edited signal file into at least one edited signal, and storing the edited signal on the electronic element; and
(10) The electronic element restarting operating according to the edited signal.

2. The method of driving an electronic element through file processing as claimed in claim 1, wherein the electronic operating platform is selected from the group consisting of a personal computer, a workstation, a PDA, a digital camera, a digital video camera, a computer for industrial controlling, and a smart mobile phone.

3. The method of driving an electronic element through file processing as claimed in claim 1, wherein the signal is selected from the group consisting of a voltage signal, a current signal, an on/off signal, and a frequency signal.

4. The method of driving an electronic element through file processing as claimed in claim 1, wherein the edited signal is selected from the group consisting of a voltage signal, a current signal, an on/off signal, and a frequency signal.

5. The method of driving an electronic element through file processing as claimed in claim 1, wherein the electronic element is a memory chip.

6. The method of driving an electronic element through file processing as claimed in claim 5, wherein the memory chip is selected from the group consisting of RAM and ROM.

7. The method of driving an electronic element through file processing as claimed in claim 1, wherein the file processing unit is able to do different edit actions on the signal file, including overwrite, copy, delete, edit, browse, change filename, and modify file attribute.

8. The method of driving an electronic element through file processing as claimed in claim 1, wherein the file processing unit is able to do different edit actions on the edited signal file, including overwrite, copy, delete, edit, browse, change filename, and modify file attribute.

9. The method of driving an electronic element through file processing as claimed in claim 1, wherein the signal file is transmitted and edited over a network.

10. The method of driving an electronic element through file processing as claimed in claim 1, wherein the edited signal file is transmitted and edited over a network.
